(19) United States
(12) Patent Application Publication
(10) Pub. No.: US 2013/0175765 A1
(43) Pub. Date: Jul. 11, 2013

(54) MUDDY WATER ROTATION DEVICE

(71) Applicants: Hiroyuki Nomaguchi, Tokyo (JP); Katsuhiko Yokohama, Tokyo (JP); Osamu Shinada, Tokyo (JP); Yoshinori Koyama, Tokyo (JP)

(72) Inventors: Hiroyuki Nomaguchi, Tokyo (JP); Katsuhiko Yokohama, Tokyo (JP); Osamu Shinada, Tokyo (JP); Yoshinori Koyama, Tokyo (JP)

(73) Assignee: Mitsubishi Heavy Industries, Ltd., Tokyo (JP)

(21) Appl. No.: 13/824,485

(22) PCT Filed: Nov. 1, 2011
(86) PCT No.: PCT/JP2011/075193

§ 371 Date: Mar. 18, 2013

(30) Foreign Application Priority Data
Nov. 10, 2010 (JP) 2010-252061

(51) Int. Cl. F16J 15/46

(52) U.S. Cl. CPC B67B 7/24
USPC 277/583

(57) ABSTRACT

This invention includes a container 2, a rotation shaft 4 penetrating through the container 2, a seal portion 5 provided between the container 2 at a fixed-side and the rotation shaft 4 at a rotation-side, and a foreign material entry prevention unit 7 (a pump 25, a high-pressure water providing line 26, an outlet 27) for preventing fine slag, i.e., foreign material in slag hopper water 8 (muddy water), from entering into the seal portion 5. As a result, with this invention, high-pressure water flowing out of the outlet 27 can prevent fine slag from entering into the seal portion 5.

### FIELD

The present invention relates to a muddy water rotation device having a seal portion. More particularly, the invention relates to a muddy water rotation device capable of improving seal function and durability of a seal portion.

### BACKGROUND

A muddy water rotation device having a seal portion is conventionally available (for example, Patent Literature 1, Patent Literature 2, Patent Literature 3). A conventional muddy water rotation device includes a container containing muddy water, a rotation shaft penetrating through the container, and a seal portion provided between the container at the fixed-side and the rotation shaft at the rotation-side. In this case, the muddy water rotation device means, for example, a slag discharge device of a coal gasifier provided in coal gasification combined cycle power generation equipment and combustion equipment, a sludge collection device provided in wastewater treatment facility, muddy water rotation devices provided in various kinds of construction devices, or the like. In such muddy water rotation device, it is important to improve the seal function and the durability of the seal portion.

### CITATION LIST

### Patent Literature

Patent Literature 1: Japanese Patent Laid-open No. 2000-104835

Patent Literature 2: Japanese Patent Laid-open No. 2005-238114

Patent Literature 3: Japanese Patent Laid-open No. 2007-139030

### SUMMARY

### Technical Problem

A problem to be solved by this invention is to improve seal function and durability of a seal portion in a muddy water rotation device.

### Solution to Problem

According to an aspect of the present invention, a muddy water rotation device includes: a container for containing muddy water; a rotation shaft for penetrating through the container; a seal portion provided between the container at a fixed-side and the rotation shaft at a rotation-side; and a foreign material entry prevention unit for preventing a foreign material in the muddy water from entering into the seal portion.

Advantageously, in the muddy water rotation device, the foreign material entry prevention unit includes a high-pressure purge line system to cause water of a pressure higher than a pressure in the container to flow out to an opposite side to the seal portion in the container.

Advantageously, in the muddy water rotation device, the high-pressure purge line system includes: a pump disposed outside of the container to feed water of a pressure higher than the pressure in the container; a high-pressure water providing line one end of which is connected to the pump and the other end of which is located on an inner-side surface of the container; and an outlet disposed at the other end of the high-pressure water providing line to cause the high-pressure water to flow to an opposite side to the seal portion in the container.

Advantageously, in the muddy water rotation device, the high-pressure purge line system includes: a pump disposed outside of the container to feed water of a pressure higher than the pressure in the container; a high-pressure water providing line one end of which is connected to the pump and the other end of which is located on an inner-side surface of the container; an outlet disposed at the other end of the high-pressure water providing line to cause the high-pressure water to flow to an opposite side to the seal portion in the container; a check valve provided in the high-pressure water providing line, to cause the high-pressure water to flow from the pump to the outlet while preventing the muddy water from flowing from the outlet to the pump; a detection device for detecting stop of rotation of the rotation shaft; and a controller that is connected to each of the detection device and the pump, and output a drive stop signal to the pump on the basis of a detection signal from the detection device.

Advantageously, in the muddy water rotation device, the outlet is provided over an entire periphery of the seal portion.

Advantageously, in the muddy water rotation device, the foreign material entry prevention unit includes: a flange disposed on the rotation shaft in the container so as to face the seal portion; and a guide disposed on an inner-side surface of the container so as to cover an outer peripheral side of the flange.

Advantageously, in the muddy water rotation device, the guide is provided to cover the entire periphery of the flange.

### Advantageous Effects of Invention

The muddy water rotation device according to this invention (a first aspect of the invention) uses the foreign material entry prevention unit to prevent the foreign material in the muddy water contained in the container from entering into the seal portion. As a result, the muddy water rotation device according to this invention (the first aspect of the invention) can improve the seal function and the durability of the seal portion.

In the muddy water rotation device according to this invention (a second aspect of the invention), the high-pressure purge line system of the foreign material entry prevention unit causes water of a pressure higher than the pressure in the container to flow into the container to the other side of the seal portion. Therefore, in the muddy water rotation device according to this invention (the second aspect of the invention), with the high-pressure water, the foreign material in the muddy water contained in the container entering into the seal portion can be pushed back to the opposite side to the seal portion, and the foreign material can be prevented from entering into the seal portion. As a result, the muddy water rotation device according to this invention (the second aspect of the invention) can improve the seal function and the durability of the seal portion.

In the muddy water rotation device according to this invention (a third aspect of the invention), the water of a pressure higher than the pressure in the container provided from the pump flows from the outlet by way of the high-pressure water providing line into the container to the opposite side to the seal portion. For this reason, in the muddy water rotation device according to this invention (the third aspect of the invention), with the high-pressure water, the foreign material in the muddy water contained in the container entering into the seal portion can be pushed back to the opposite side to the seal portion, and the foreign material can be prevented from entering into the seal portion. As a result, the muddy water rotation device according to this invention (the third aspect of the invention) can improve the seal function and the durability of the seal portion.

Like the muddy water rotation device according to the invention (the third aspect of the invention), the muddy water rotation device according to this invention (a fourth aspect of the invention) is configured such that the water of a pressure higher than the pressure in the container provided from the pump flows from the outlet by way of the high-pressure water providing line into the container to the opposite side to the seal portion. For this reason, in the muddy water rotation device according to this invention (the fourth aspect of the invention), with the high-pressure water, the foreign material in the muddy water contained in the container entering into the seal portion can be pushed back to the opposite side to the seal portion, and the foreign material can be prevented from entering into the seal portion. As a result, the muddy water rotation device according to this invention (the fourth aspect of the invention) can improve the seal function and the durability of the seal portion.

Moreover, the muddy water rotation device according to this invention (the fourth aspect of the invention) uses the detection device and the controller, so that when the rotation shaft rotates, the pump is driven to prevent the foreign material from entering into the seal portion. On the other hand, when the rotation shaft is at a stop, the pump can be stopped. More specifically, the pump can be driven intermittently. As a result, the muddy water rotation device according to this invention (the fourth aspect of the invention) can improve the seal function and the durability of the seal portion, and in addition, the muddy water rotation device according to this invention (the fourth aspect of the invention) can reduce the use of the high-pressure water (water for purging the foreign material) and can improve the durability of the pump.

The muddy water rotation device according to this invention (a fifth aspect of the invention) can cause the high-pressure water to flow through the entire periphery of the seal portion, and therefore, the muddy water rotation device according to this invention (the fifth aspect of the invention) can prevent the foreign material from entering into the seal portion over the entire periphery of the seal portion, and can improve the seal function and the durability of the seal portion in a more reliable manner.

The muddy water rotation device according to this invention (a sixth aspect of the invention) uses the guide and the flange to form the labyrinth to the seal portion in the container, and the labyrinth prevents the foreign material from entering into the seal portion. As a result, the muddy water rotation device according to this invention (the sixth aspect of the invention) can improve the seal function and the durability of the seal portion.

In the muddy water rotation device according to this invention (a seventh aspect of the invention), the guide is provided over the entire periphery of the flange, and therefore, the foreign material is prevented from entering into the seal portion over the entire periphery of the seal portion, and the seal function and the durability of the seal portion can be improved in a more reliable manner.

### BRIEF DESCRIPTION OF DRAWINGS

FIG. 1 is a partial longitudinal cross-sectional view (partial vertical cross-sectional view) of an essential portion illustrating a first embodiment of a muddy water rotation device according to this invention.

FIG. 2 is likewise a partial schematic longitudinal cross-sectional view (partial schematic vertical cross-sectional view) illustrating the essential portion.

FIG. 3 is likewise a schematic cross-sectional view taken along III-III line of FIG. 2.

FIG. 4 is likewise a schematic cross-sectional view illustrating a first modification of an outlet.

FIG. 5 is likewise a schematic cross-sectional view illustrating a second modification of the outlet.

FIG. 6 is likewise a partial schematic longitudinal cross-sectional view (partial schematic vertical cross-sectional view) illustrating a slag discharge device of a coal gasifier provided in coal gasification combined cycle power generation equipment and combustion equipment.

FIG. 7 is a partial schematic longitudinal cross-sectional view (partial schematic vertical cross-sectional view) of an essential portion illustrating a second embodiment of a muddy water rotation device according to this invention.

FIG. 8 is a partial schematic longitudinal cross-sectional view (partial schematic vertical cross-sectional view) of an essential portion illustrating a third embodiment of a muddy water rotation device according to this invention.

FIG. 9 is likewise a schematic cross-sectional view taken along IX-IX line of FIG. 8.

FIG. 10 is likewise a schematic cross-sectional view illustrating a modification of a guide.

### DESCRIPTION OF EMBODIMENTS

Hereinafter, three embodiments of muddy water rotation devices according to this invention will be described in detail with reference to drawings. However, this invention is not limited by these embodiments.

### First Embodiment

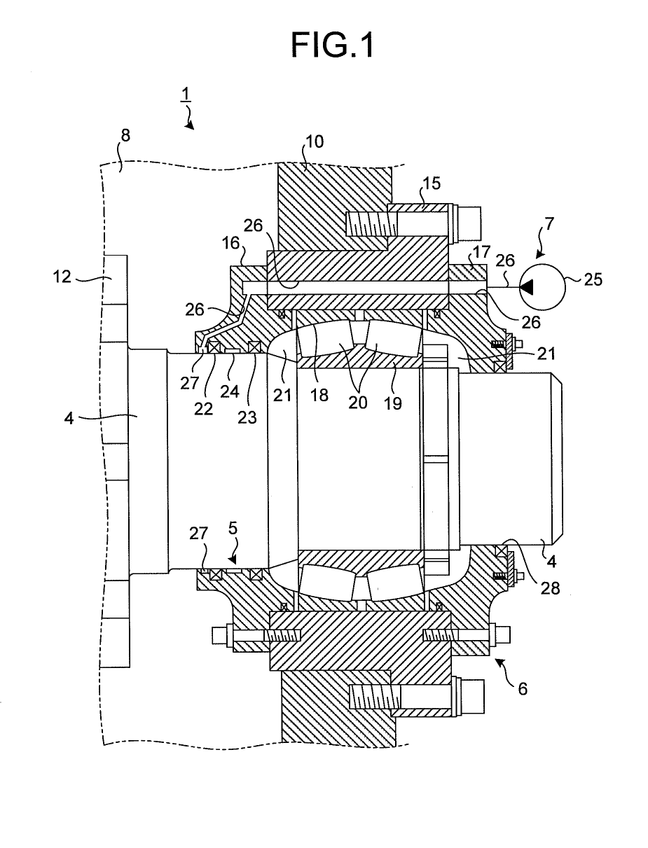

FIGS. 1 to 6 illustrate the first embodiment of the muddy water rotation device according to this invention. Hereinafter, a configuration of the muddy water rotation device according to the first embodiment will be explained.

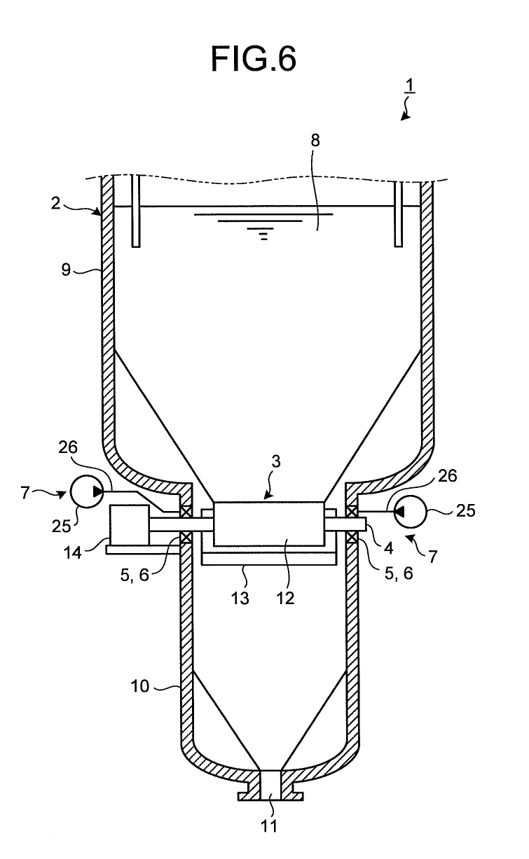

In FIG. 6, reference numeral “1” denotes a muddy water rotation device according to the first embodiment. In this example, the muddy water rotation device 1 is a slag discharge device of a coal gasifier provided in coal gasification combined cycle power generation equipment and combustion equipment.

The slag discharge device 1 includes a container 2, a rotation shaft 4 of a roll crasher 3, a seal portion 5 and a bearing portion 6, and a foreign material entry prevention unit 7. More specifically, the slag discharge device 1 includes the container 2 containing muddy water 8, the rotation shaft 4 of the roll crasher 3 penetrating through the container 2, the seal portion 5 and the bearing portion 6 provided between the container 2 at the fixed-side and the rotation shaft 4 at the rotation-side, and the foreign material entry prevention unit 7 for preventing foreign materials (not illustrated) in the muddy water 8 from entering into the seal portion 5 and the bearing portion 6.

The container 2 is, for example, a pressure container having a cylindrical shape, and includes an upper portion container 9 and a lower portion container 10 of which diameter is less than that of the upper portion container 9. The upper portion container 9 also serves as a container for a coal gasifier (not illustrated). A slag discharge port 11 is provided on a bottom portion of the lower portion container 10.

The muddy water 8, i.e., slag hopper water 8, is contained in the container 2 (the upper portion container 9 and the lower portion container 10). The container 2 is sealed and held at a high pressure such as about 3 PMa. As a result, the slag hopper water 8 is at a high pressure, i.e., about 3 PMa.

In the upper portion of the lower portion container 10, the roll crasher (slag crusher, slag breaker) 3 is provided. The roll crasher 3 includes rotating teeth 12 and fixed teeth 13 provided in the lower portion container 10 and a motor 14 provided outside of the lower portion container 10. The rotating teeth 12 is fixed to an intermediate portion of the rotation shaft 4, and is attached to the lower portion container 10 via the rotation shaft 4 in an rotatable manner. The fixed teeth 13 is fixed on the lower portion container 10 to face the rotating teeth 12. The motor 14 is coupled with an end of the rotation shaft 4 via a speed reduction mechanism and a rotating force transmission mechanism (not illustrated), and is configured to rotate the rotating teeth 12 via the rotation shaft 4.

In the coal gasifier, as the coal is gasified, melted slag (not illustrated) is generated. The melted slag drops from the main body of the coal gasifier into the upper portion container 9, and is cooled and solidified by the slag hopper water 8 in the upper portion container 9. The solidified slag is crushed (broken) by the fixed teeth 13 and the rotating teeth 12 of the roll crasher 3. The crushed slag is discharged from the slag discharge port 11 of the lower portion container 10 to the outside. When the solidified slag is crushed by the roll crasher 3, fine slag is generated. Therefore, in slag hopper water 8, fine slag (foreign material) exists.

The rotation shaft 4 penetrates the wall portion of the lower portion container 10 in a horizontal direction (a vertical direction or a perpendicular direction to a dropping direction of the slag in the container 2). Both ends of the rotation shaft 4 are attached to the wall portion of the lower portion container 10 via the bearing portion 6 in a rotatable manner. The intermediate portion of the rotation shaft 4 as well as the rotating teeth 12 is located in the lower portion container 10. Both end portions of the rotation shaft 4 are located outside of the lower portion container 10.

The bearing portion (bearing mechanism, bearing structure) 6 is the same as a self-aligning roller bearing of Patent Literature 2 and Patent Literature 3. As illustrated in FIG. 1, the bearing portion 6 includes a cylindrical bearing box 15, a ring-shaped inner-side bearing cover (seal housing) 16, likewise, a ring-shaped outer-side bearing cover (seal housing) 17, a bearing outer rim 18, a bearing inner rim 19, and multiple self-aligned rollers 20. In the bearing portion 6, a lubricant chamber 21 is formed. In the lubricant chamber 21, lubricant oil (not illustrated) is filled via a lubricant oil providing line system (not illustrated). When the solidified slag is crushed by the fixed teeth 13 and the rotating teeth 12 of the roll crasher 3, the bearing portion 6 supports bending stress in a radius direction occurring in the rotation shaft 4.

The seal portion 5 is the same as seal portion as Patent Literature 2 and Patent Literature 3. As illustrated in FIG. 1, the seal portion 5 includes a container-side seal (inner-side seal) 22, a bearing-side seal (outer-side seal) 23, and an intermediate seal 24 provided on an inner-peripheral surface of the inner-side bearing cover 16. The intermediate seal 24 is made by filling seal water (not illustrated) in a seal water chamber provided in the inner-side bearing cover 16 via a seal water providing line system (not illustrated). An outer-side seal 28 is provided on the inner-peripheral surface of the outer-side bearing cover 17. The outer-side seal 28 prevents the lubricant oil in the lubricant chamber 21 of the bearing portion 6 from leaking to the outside through a gap between the outer-peripheral surface of the rotation shaft 4 and the inner-peripheral surface of the outer-side bearing cover 17.

The pressure of the slag hopper water 8 in the container 2 is about 3 PMa. The pressure of the lubricant oil in the lubricant chamber 21 is higher than the pressure of the slag hopper water 8 in the container 2. More specifically, the pressure of the lubricant oil in the lubricant chamber 21 is, for example, about 4 PMa. The pressure of the seal water in the seal water chamber of the intermediate seal 24 is higher than the pressure of the slag hopper water 8 in the container 2 and is the same as or less than the pressure of the lubricant oil in the lubricant chamber 21. More specifically, the pressure of the seal water in the seal water chamber of the intermediate seal 24 is, for example, about 3.5 PMa. As a result, the seal water of the intermediate seal 24 leaks to the inside of the lower portion container 10 via the container-side seal 22. This maintains the sliding surface with the rotation shaft 4 of the container-side seal 22 in a normal state, and improves the reliability of the seal portion 5. On the other hand, the seal water of the intermediate seal 24 is prevented from entering into the lubricant chamber 21 of the bearing portion 6. This improves the reliability of the bearing portion 6.

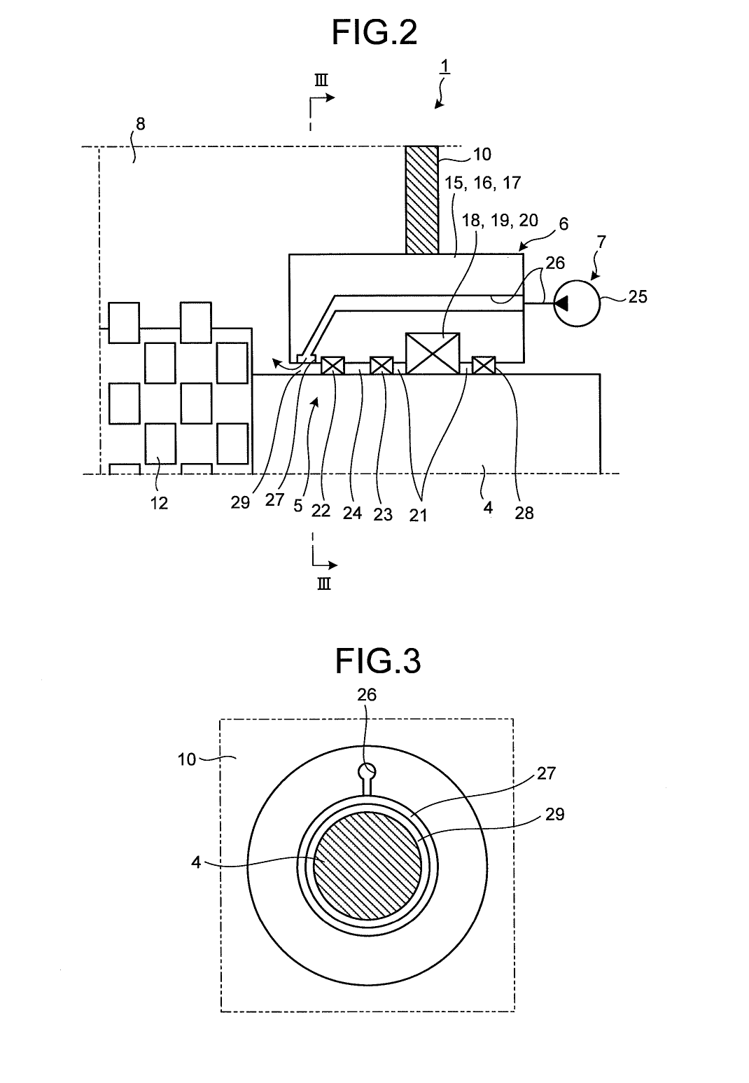

The foreign material entry prevention unit 7 is constituted by a high-pressure purge line system for causing water (not illustrated) of a higher pressure than the pressure of the slag hopper water 8 in the container 2, i.e., the pressure in the container 2, to flow to the opposite side to the container-side seal 22 of the seal portion 5 in the lower portion container 10 of the container 2 as illustrated by an arrow of solid line in FIG. 2.

The high-pressure purge line system includes a pump 25, a high-pressure water providing line 26, and an outlet 27. The high-pressure purge line system, the seal water providing line system, and the lubricant oil providing line system are provided independently so as not to interfere with each other.

The pump 25 is disposed outer-side of the container 2 and provides water of a higher pressure than the pressure in the container 2.

The high-pressure water providing line 26 is provided between an exhaust port of the pump 25 and the inner-side surface of the lower portion container 10, i.e., the container 2, which is the inner-peripheral surface of the inner-side bearing cover 16 of the bearing portion 6. More specifically, the high-pressure water providing line 26 is provided in the bearing box 15, the inner-side bearing cover 16, and the outer-side bearing cover 17 of the bearing portion 6, and is provided between an inlet of the outer-side surface of the outer-side bearing cover 17 and a protruding port of the pump 25. One end of the high-pressure water providing line 26 is connected to the exhaust port of the pump 25. The other end of the high-pressure water providing line 26 is located on the inner-side surface of the lower portion container 10, i.e., the container 2, which is the inner-peripheral surface of the inner-side bearing cover 16 of the bearing portion 6.

The outlet 27 is provided at the other end of the high-pressure water providing line 26. More specifically, the outlet 27 is provided on the inner-peripheral surface of the inner-side bearing cover 16 to face the outer-peripheral surface of the rotation shaft 4. The outlet 27 is to cause the high-pressure water provided from the pump 25 to a gap 29 between the outer-peripheral surface of the rotation shaft 4 and the inner-peripheral surface of the inner-side bearing cover 16 in the lower portion container 10, i.e., the container 2, to the side opposite to the seal portion 5, as illustrated by an arrow of solid line in FIG. 2. As illustrated in FIG. 3, the outlet 27 is provided on the entire periphery of the inner-peripheral surface of the inner-side bearing cover 16 of the seal portion 5.

The seal portion 5, the bearing portion 6, and the foreign material entry prevention unit 7, the details of which are illustrate in FIGS. 1 to 3, are arranged at one end (right end) of the rotation shaft 4. As illustrated in FIG. 6, the seal portion 5, the bearing portion 6, and the foreign material entry prevention unit 7 are arranged at both ends of the rotation shaft 4.

The muddy water rotation device according to the first embodiment is configured as described above, and the effects of the muddy water rotation device according to the first embodiment will be hereinafter explained.

The melted flag generated in the coal gasifier drops from the main body of the coal gasifier into the upper portion container 9, and is cooled and solidified by the slag hopper water 8 in the upper portion container 9. The solidified slag is crushed by the fixed teeth 13 and the rotating teeth 12 rotated by the motor 14 of the roll crasher 3. The crushed slag is discharged to the outside through the slag discharge port 11 of the lower portion container 10. When the solidified slag is crushed by the roll crasher 3, fine slag is generated. Therefore, in slag hopper water 8, fine slag exists as foreign material.

Then, with the foreign material entry prevention unit 7, the pump 25 provides water of a pressure higher than the pressure of the slag hopper water 8 in the container 2 (lower portion container 10). This high-pressure water is provided to the outlet 27 through the high-pressure water providing line 26. The high-pressure water flows from the outlet 27 to the gap 29 between the outer-peripheral surface of the rotation shaft 4 and the inner-peripheral surface of the inner-side bearing cover 16 in the container 2 (lower portion container 10), to the side opposite to the seal portion 5, as illustrated by an arrow of solid line in FIG. 2. As illustrated in FIG. 3, the high-pressure water flows out through the entire periphery of the inner-peripheral surface of the inner-side bearing cover 16.

With the water curtain effect of the high-pressure water flowing out from the outlet 27, fine slag in the slag hopper water 8 entering into the gap 29 between the outer-peripheral surface of the rotation shaft 4 and the inner-peripheral surface of the inner-side bearing cover 16 is pushed back into the container 2 (lower portion container 10) which is opposite to the seal portion 5.

The muddy water rotation device according to the first embodiment is made of the above configuration and actions, and the effects thereof will be hereinafter explained.

With the high-pressure water flowing out from the outlet 27 of the muddy water rotation device according to the first embodiment, fine slag in the slag hopper water 8 entering into the gap 29 between the outer-peripheral surface of the rotation shaft 4 and the inner-peripheral surface of the inner-side bearing cover 16 can be pushed back into the container 2 (lower portion container 10) to the opposite to the seal portion 5. As a result, the muddy water rotation device according to the first embodiment can prevent the fine slag from entering into the seal portion 5 (sliding surface of the container-side seal 22 with the rotation shaft 4), and therefore, the seal function and the durability of the seal portion 5 can be improved.

The muddy water rotation device according to the first embodiment can cause the high-pressure water to flow through the entire periphery of the seal portion 5, and therefore, the muddy water rotation device according to the first embodiment can prevent fine slag, i.e., foreign material, from entering into the seal portion 5 over the entire periphery of the seal portion 5, and can improve the seal function and the durability of the seal portion 5 in a more reliable manner.

With the high-pressure water of the muddy water rotation device according to the first embodiment, fine slag in the slag hopper water 8 entering into the seal portion 5 can be pushed back into the container 2 which is opposite to the seal portion 5, and the fine slag is prevented from entering into the seal portion 5, and therefore, the muddy water rotation device according to the first embodiment is suitable for the slag discharge device of which pressure in the container 2 is high pressure, e.g., about 3 MPa.

Now, a case where a lip seal is used instead of the foreign material entry prevention unit 7 will be explained. In the slag discharge device 1 of the muddy water rotation device according to the first embodiment, the rotation shaft 4 is constantly moved due to the load when the slag is crushed, and the container 2 is maintained at a high pressure, e.g., about 3 MPa. For this reason, it is difficult for the lip seal to prevent fine slag from entering into the seal portion 5. In contrast, in the muddy water rotation device according to the first embodiment, the high-pressure water can prevent fine slag from entering into the seal portion 5.

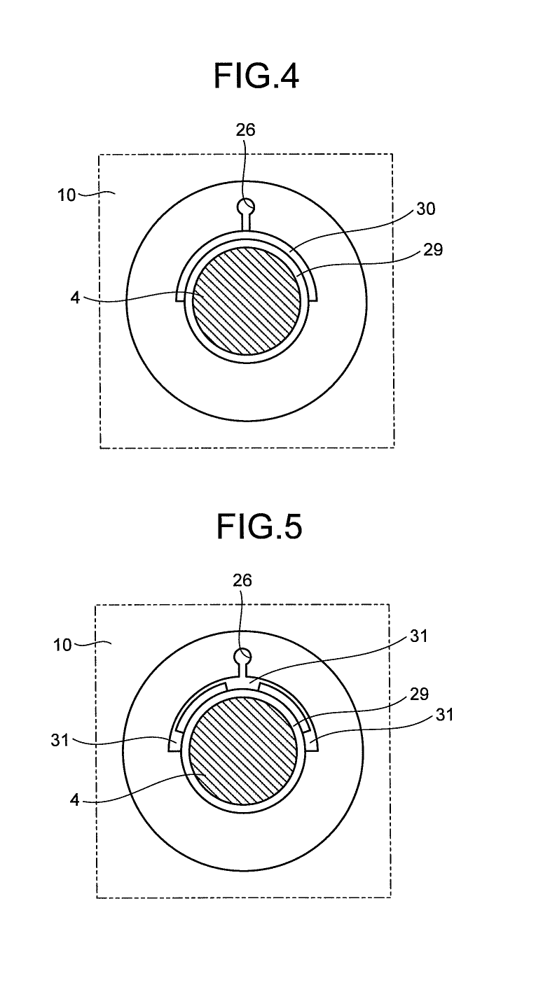

FIG. 4 is a schematic cross-sectional view illustrating a first modification of an outlet. In FIG. 4, the same reference numerals as those of FIGS. 1 to 3 denote the same. An outlet 30 according to the first modification is provided at an upper-side half of the periphery of the inner-peripheral surface of the inner-side bearing cover 16 of the seal portion 5. The outlet 30 of the first modification can achieve substantially the same actions and effects as the outlet 27 provided along the entire periphery of the inner-peripheral surface of the inner-side bearing cover 16 of the seal portion 5 (see FIG. 3).

FIG. 5 is a schematic cross-sectional view illustrating a second modification of an outlet. In FIG. 5, the same reference numerals as those of FIGS. 1 to 4 denote the same. Outlets 31 of the second modification are provided at three portions, i.e., the upper side, the left side, and the right side, of the inner-peripheral surface of the inner-side bearing cover 16 of the seal portion 5. The outlets 31 according to the second modification can achieve substantially the same actions and effects as the outlet 27 as illustrated in FIG. 3 and the outlet 30 as illustrated in FIG. 4.

### Second Embodiment

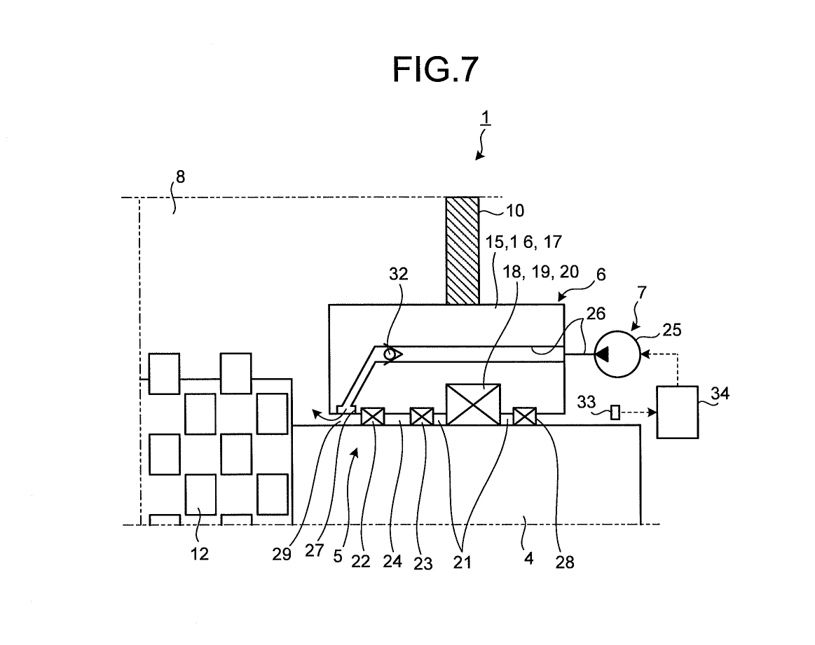

FIG. 7 illustrates the second embodiment of a muddy water rotation device according to this invention. Hereinafter, the muddy water rotation device according to the second embodiment will be explained. In FIG. 7, the same reference numerals as those of FIGS. 1 to 6 denote the same.

As illustrated in FIG. 7, in the muddy water rotation device according to the second embodiment, a high-pressure purge line system includes the pump 25, the high-pressure water providing line 26, and the outlet 27 (or 30 or 31) of the high-pressure purge line system of the muddy water rotation device of the first embodiment, and also includes a check valve 32, a detection device 33, and a controller 34.

The check valve 32 is provided in the high-pressure water providing line 26. The check valve 32 allows the high-pressure water to flow from the pump 25 to an outlet 27, but prevents the slag hopper water 8 from flowing from the outlet 27 to the pump 25. The detection device 33 detects stop of rotation of the rotation shaft 4, and outputs a detection signal thereof. The controller 34 is connected to each of the detection device 33 and the pump 25. The controller 34 outputs a drive stop signal to the pump 25 on the basis of the detection signal from the detection device 33.

The muddy water rotation device according to the second embodiment is configured as described above, and therefore, the muddy water rotation device according to the second embodiment can achieve substantially the same actions and effects as the muddy water rotation device according to the first embodiment. Moreover, the muddy water rotation device according to the second embodiment uses the detection device 33 and the controller 34, so that when the rotation shaft 4 rotates, the pump 25 is driven to prevent fine slag, i.e., foreign material, from entering into the seal portion 5. On the other hand, when the rotation shaft 4 is at a stop, the pump 25 can be stopped. More specifically, the pump 25 can be operated intermittently. As a result, the muddy water rotation device according to the second embodiment can improve the seal function and the durability of the seal portion 5, and in addition, the muddy water rotation device according to the second embodiment can reduce the use of the high-pressure water (water for purging foreign material) and can improve the durability of the pump 25. Moreover, the high-pressure water can be saved, and the operation cost can be inexpensive.

### Third Embodiment

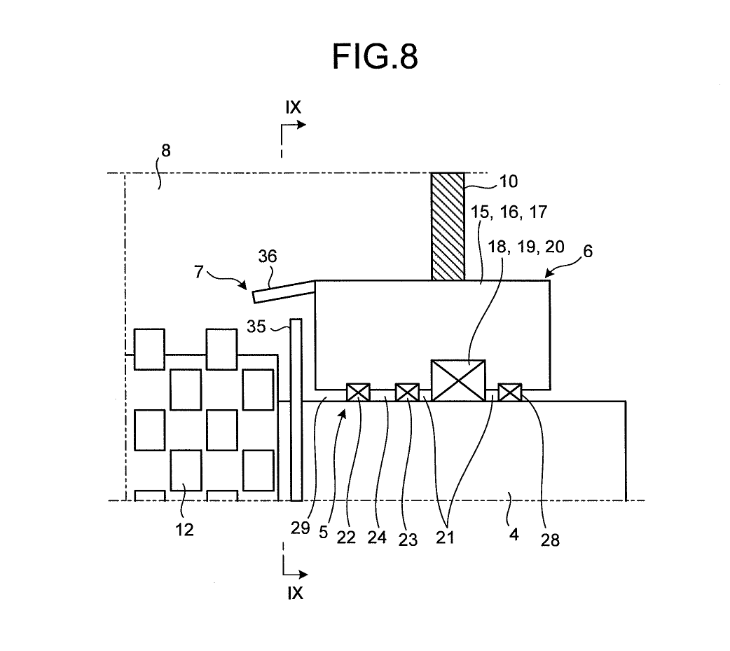

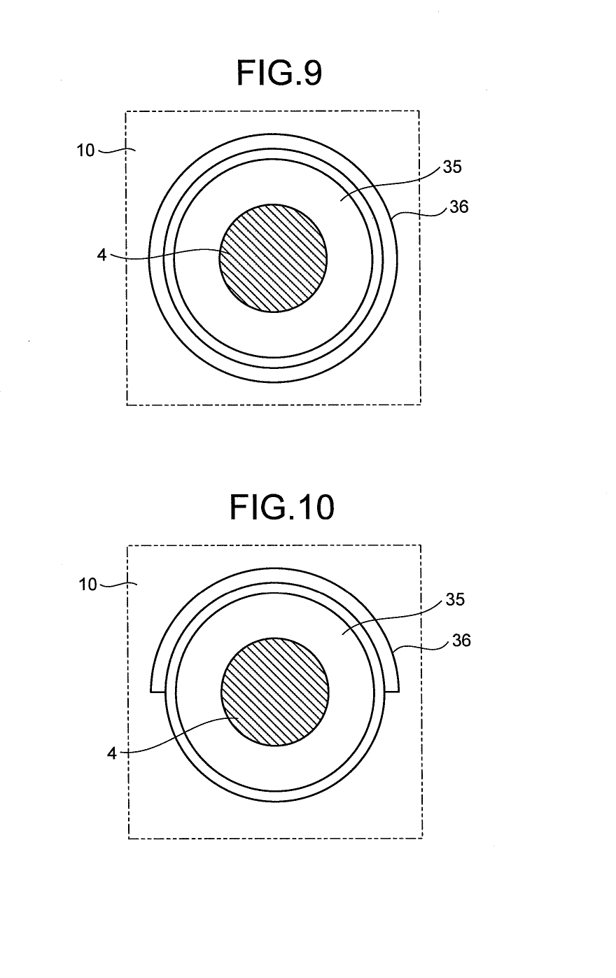

FIGS. 8 and 9 illustrate the third embodiment of the muddy water rotation device according to this invention. Hereinafter, the muddy water rotation device according to the third embodiment will be explained. In FIGS. 8 and 9, the same reference numerals as those of FIGS. 1 to 7 denote the same.

As illustrated in FIGS. 8 and 9, in the muddy water rotation device according to the third embodiment, the foreign material entry prevention unit 7 includes a flange 35 and a guide 36. The flange 35 and the guide 36 are constituted by a corrosion resistive member, for example, stainless-steel.

The flange 35 is provided on the rotation shaft 4 in the container 2 (lower portion container 10), so as to face the container-side seal 22 of the seal portion 5 and the inner-side bearing cover 16 of the bearing portion 6. As illustrated in FIG. 9, the flange 35 is in a circular plate shape. The diameter of the flange 35 is less than the diameter of the inner-side bearing cover 16 of the bearing portion 6. The guide 36 is provided on the inner-side surface of the container 2 (lower portion container 10) which is the inner-side surface of the inner-side bearing cover 16 of the bearing portion 6, so as to cover the outer-peripheral side of the flange 35. As illustrated in FIG. 9, the guide 36 is in a cylindrical shape, and is provided to cover the entire periphery of the flange 35.

The muddy water rotation device according to the third embodiment is configured as described above, and therefore, the muddy water rotation device according to the third embodiment can achieve substantially the same actions and effects as the muddy water rotation device according to the first and second embodiments. More specifically, in the muddy water rotation device according to the third embodiment, the guide 36 and the flange 35 forms a labyrinth to the seal portion in the container 2 (lower portion container 10). The labyrinth includes a portion protruding from the flange 35 of the guide 36 to the inner-side of container 2 (lower portion container 10), a portion between the external peripheral end surface of the flange 35 and a central portion of the inner-peripheral surface of the guide 36, a portion between the outer-side surface of the flange 35 and the inner-side surface of the inner-side bearing cover 16 of the bearing portion 6, and a gap 29 between the outer-peripheral surface of the rotation shaft 4 and the inner-peripheral surface of the inner-side bearing cover 16 of the bearing portion 6. This labyrinth can prevent fine flag, i.e., foreign material, from entering into the seal portion 5, and can improve the seal function and the durability of the seal portion 5.

Moreover, the muddy water rotation device according to the third embodiment uses the flange 35 and the guide 36, instead of the high-pressure purge line system (the pump 25, the high-pressure water providing line 26, the outlets 27, 30, 31, the check valve 32, the detection device 33, and the controller 34) of the muddy water rotation device of the first and second embodiments, and therefore, the manufacturing cost of the muddy water rotation device according to the third embodiment is inexpensive.

Further, in the muddy water rotation device according to the third embodiment, the guide 36 is provided on the entire periphery of the flange 35, and therefore, fine slag, i.e., foreign material, is prevented from entering into the seal portion 5 over the entire periphery of the seal portion 5, and the seal function and the durability of the seal portion 5 can be improved in a more reliable manner.

FIG. 10 is a schematic cross-sectional view illustrating a modification of a guide. In FIG. 10, the same reference numerals as those of FIGS. 1 to 9 denote the same. A guide 37 according to the modification is provided at an upper-side half of the periphery of the flange 35. The guide 37 according to the modification can achieve substantially the same actions and effects as the guide 36 provided to cover the entire periphery of the flange 35 (see FIG. 9).

In the first, second, and third embodiments, the slag discharge device 1 of a coal gasifier provided in coal gasification combined cycle power generation equipment and combustion equipment is explained as the muddy water rotation device. However, according to this invention, the muddy water rotation device may be a device other than the slag discharge device 1, such as a sludge collection device provided in wastewater treatment facility, or muddy water rotation devices provided in various kinds of construction devices.

### REFERENCE SIGNS LIST

1 slag discharge device (muddy water rotation device)

2 container

3 roll crasher

4 rotation shaft

5 seal portion

6 bearing portion

7 foreign material entry prevention unit

8 slag hopper water (muddy water)

9 upper portion container

10 lower portion container

11 slag discharge port

12 rotating teeth

13 fixed teeth

14 motor

15 bearing box

16 inner-side bearing cover

17 outer-side bearing cover

18 bearing outer rim

19 bearing inner rim

20 self-aligned roller

21 lubricant chamber

22 container-side seal

23 bearing-side seal

24 intermediate seal

25 pump

26 high-pressure water providing line

27 outlet

28 outer-side seal

29 gap

30 outlet

31 outlet

32 check valve

33 detection device

34 controller

35 flange

36 guide

37 guide

1. A muddy water rotation device comprising:
a container for containing muddy water;
a rotation shaft for penetrating through the container;
a seal portion provided between the container at a fixed-side and the rotation shaft at a rotation-side; and
a foreign material entry prevention unit for preventing a foreign material in the muddy water from entering into the seal portion.

2. The muddy water rotation device according to claim 1, wherein the foreign material entry prevention unit includes a high-pressure purge line system to cause water of a pressure higher than a pressure in the container to flow out to an opposite side to the seal portion in the container.

3. The muddy water rotation device according to claim 2, wherein the high-pressure purge line system includes:
a pump disposed outside of the container to feed water of a pressure higher than the pressure in the container;
a high-pressure water providing line one end of which is connected to the pump and the other end of which is located on an inner-side surface of the container; and
an outlet disposed at the other end of the high-pressure water providing line to cause the high-pressure water to flow to an opposite side to the seal portion in the container.

4. The muddy water rotation device according to claim 2, wherein the high-pressure purge line system includes:
a pump disposed outside of the container to feed water of a pressure higher than the pressure in the container;
a high-pressure water providing line one end of which is connected to the pump and the other end of which is located on an inner-side surface of the container;
an outlet disposed at the other end of the high-pressure water providing line to cause the high-pressure water to flow to an opposite side to the seal portion in the container;
a check valve provided in the high-pressure water providing line, to cause the high-pressure water to flow from the pump to the outlet while preventing the muddy water from flowing from the outlet to the pump;
a detection device for detecting stop of rotation of the rotation shaft; and
a controller that is connected to each of the detection device and the pump, and output a drive stop signal to the pump on the basis of a detection signal from the detection device.

5. The muddy water rotation device according to claim 3, wherein the outlet is provided over an entire periphery of the seal portion.

6. The muddy water rotation device according to claim 1, wherein the foreign material entry prevention unit includes:
a flange disposed on the rotation shaft in the container so as to face the seal portion; and
a guide disposed on an inner-side surface of the container so as to cover an outer peripheral side of the flange.

7. The muddy water rotation device according to claim 6, wherein the guide is provided to cover the entire periphery of the flange.
